(19) United States
(12) Patent Application Publication
(10) Pub. No.: US 2009/0309744 A1
(43) Pub. Date: Dec. 17, 2009

(54) SYSTEM AND METHOD OF DETECTING AIR POLLUTION, ROUTE-PLANNING METHOD APPLIED TO SAID DETECTION SYSTEM, AND WARNING METHOD OF AIR POLLUTION

(75) Inventors: Huai-Lei Fu, Taipei (TW); Kai-Hsiang Hu, Taipei (TW); Ting-Yu Wang, Taipei (TW); Zih-Ci Lin, Taipei (TW); Phone Lin, Taipei (TW); Yuguang Fang, Taipei (TW)

Correspondence Address: EDWARDS ANGELL PALMER & DODGE LLP, P.O. BOX 55874, BOSTON, MA, 02205, US

(73) Assignee: National Taiwan University, Taipei (TW)

(21) Appl. No.: 12/408,241

(22) Filed: Mar. 20, 2009

(30) Foreign Application Priority Data
Jun. 13, 2008 (TW) 097122055

(51) Int. Cl. G08B 17/10; G06F 19/00; G01W 1/02

(52) U.S. Cl. 340/632; 702/24; 702/3

(57) ABSTRACT

Provided are a system and method for detecting air pollution, characterized by using an air pollution detecting device for detecting air pollutants, using a positioning device for locating the air pollution detecting device, and enabling a data transmission device to transmit air pollution data and position data to a data analysis and management device via a network system, and then enabling the data analysis and management device to perform analysis and management process on the data; accordingly, perceiving air pollution status at each area and thus proving air pollution information and improvement to air pollution areas in a shorter time.

### BACKGROUND OF THE INVENTION

1. Field of the Invention

This invention generally relates to a system for detecting air pollution and a method applied thereto, and more specifically, to a movable real-time air pollution detection system and a method applied thereto.

2. Description of Related Art

There are various kinds of chemical particles in the air we breathe every day. Given endurable concentration, the chemical particles generally have no direct ecological influence on our daily life. However, there are more and more chemical components exhausted into the air because of industry development and internal combustion engines widely adopted by various transportation devices; and it is very common to have a hazardous chemical component above a safety level. Once a hazardous chemical component is above safety level, air pollution will happen.

There are many sources of air pollution, including: power plants, vehicles, industry plants, etc. Generally speaking, a power plant is usually a major source of air pollution, and secondary sources of air pollution are vehicular exhausted gas and industrial exhausted gas. There are many kinds of pollutants, and the most common and measured air pollutants are: carbon dioxide (CO₂), carbon monoxide (CO), sulfur dioxide (SO₂), nitric oxide (NO), nitrogen dioxide (NO₂), nitrous oxide (N₂O), suspended particles (PM 10 or PM 2.5), ozone (O₃), etc.

We human beings and our environment are directly and indirectly influenced by air pollution. Air pollution has a direct negative effect on the health of human bodies, plants, and animals. Indirectly, air pollution causes acid rain and global warming. The aforesaid predicaments facing human beings nowadays are lessened by means of monitoring and improving situation of air pollution.

Existing established air pollution detecting devices are mostly fixed devices and commonly installed at some particular locations, such as factories or areas with heavy traffic, by government or community organizations, and then judgment of local air pollution situation is made according to data acquired via the air pollution detecting device for subsequent execution of improvement programs.

However, technique of the established devices has the following drawbacks:
(1) area under detection is not wide enough; due to restriction of the established technique or insufficient budge, the air pollution detecting device is commonly installed at a fixed location, thereby incapable of detecting air pollution occuring at other places; even though a dynamic air pollution detection is carried out by using a movable air pollution detecting device, it should be first considered that if the government or community organization has enough budge for supporting vast expenditure of manpower and material;
(2) insufficient timing effect and interaction; air pollution situation has great impact on heath of residents, also air pollution detecting device generally has to transmit detected data back to a control center, and then the control center broadcasts information to network or media after analyzing the detected data, therefore, general public can only receive the information passively with insufficient timing effect and interaction.

Hence, it is a highly urgent issue in the industry for how to provide an air pollution detection system for effectively solving the drawbacks of the prior arts as mentioned above.

### SUMMARY OF THE INVENTION

In view of the disadvantages of the prior art mentioned above, it is a primary objective of the present invention to provide an air pollution detection system, which is applicable to network system; the air pollution detection system comprises: an air pollution detecting device for detecting air pollutants; a positioning device for locating the air pollution detecting device; a data transmission device for transmitting air pollution data detected by and received from the air pollution detecting device and position data received from the positioning device via the network system; and a data analysis and management device for receiving the air pollution data and the position data transmitted from the data transmission device, and then performing process of analysis and management on the data.

It is another objective of the present invention to provide an air pollution detection method which is applicable to air pollution detection system. The air pollution system comprises an air pollution detecting device, a positioning device, a data transmission device, and a data analysis and management device. The air pollution detection method comprises: (1) commanding the air pollution device to detect air pollution data; (2) commanding the positioning device to locate the air pollution detecting device; (3) commanding the data transmission device to transmit the air pollution data and the position data to the data analysis and management device via network system; and (4) commanding the data analysis and management device to perform analysis process on received air pollution data and position data.

It is a further objective of the present invention to provide an air pollution path planning method which is applicable to an air pollution detection system. The air pollution path planning method comprises: (1) commanding a subscriber device to transmit origin data and destination data to a data analysis and management device; (2) commanding the data analysis and management device to perform a comparison process on the received origin data and destination data with air pollution data of database; (3) commanding the data analysis and management device to plan one or a plurality of low air pollution paths according to the outcome of the comparison process; and (4) transmitting the paths to the subscriber device.

It is still another objective of the present invention to provide an air pollution alarming method which is applicable to an air pollution detection system. The air pollution alarming method comprises: (1) commanding a subscriber device to transmit location thereof and an air pollution default value to the data analysis and management device via a network system; (2) commanding the data analysis and management device to perform a comparison process on the location data and the air pollution default value with data of the database; and (3) if an index of air pollution of the location thereof is higher than the air pollution default value, commanding the data analysis and management device to transmit an alarm message to the subscriber device.

Compared with the prior art, the air pollution detection system and method of the present invention overcome drawbacks of conventional fixed air pollution detecting devices, and the air pollution detection system of present invention is capable of transmitting detected data and real-time position data back to a control center via the network system by means of a movable detection device and a communication transmission device, and thus enabling the control center to obtain air pollution data of a wider area. Also, the control center is capable of transmitting information of air quality to the subscriber device of each area in real time, thereby enabling subscribers to perceive air pollution situation in real time and take proper protective measures, such as wearing a mask or taking a retreat action (i.e., retreating from the polluted area), thereby solving drawbacks of the conventional pollution detection devices, namely providing a limited detection area of application and insufficient real-time interaction.

### BRIEF DESCRIPTION OF DRAWINGS

The present invention can better be understood by reading the following detailed description of the preferred embodiments, with reference made to the accompanying drawings, wherein:

FIG. 1 is an architecture diagram of an air pollution detection system of the present invention;

FIG. 2 is an application architecture diagram illustrating a specific embodiment of the air pollution detection system of the present invention;

FIG. 3 is an architecture diagram illustrating another specific embodiment of the air pollution detection system of the present invention;

FIG. 4 is a flowchart illustrating an air pollution detection method of the present invention;

FIG. 5 is a flowchart illustrating a specific embodiment of the air pollution detection method of the present invention;

FIG. 6 is a flowchart illustrating an air pollution path planning method of the present invention; and

FIG. 7 is a flowchart illustrating an air pollution alarming method of the present invention.

### DETAILED DESCRIPTION OF PREFERRED EMBODIMENTS

The following illustrative embodiments are provided to illustrate the disclosure of the present invention, these and other advantages and effects can be apparently understood by those in the art after reading the disclosure of this specification. The present invention can also be performed or applied by other different embodiments. The details of the specification may be on the basis of different points and applications, and numerous modifications and variations can be devised without departing from the spirit of the present invention.

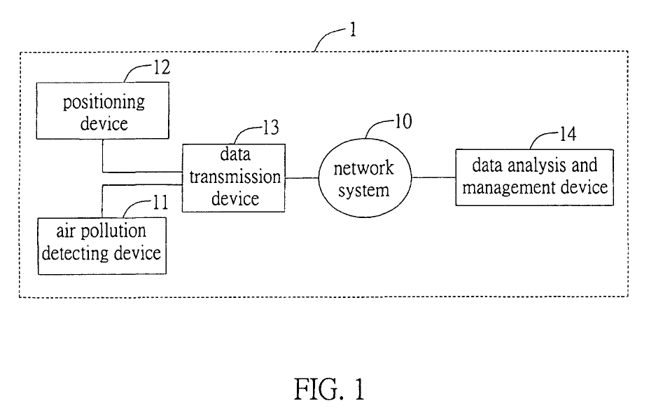

Please refer to FIG. 1, which is an architecture diagram of air pollution detection system of the present invention; as shown in the FIG., the present invention is applicable to a network system 10, and the air pollution detection system 1 comprises air pollution detecting device 11, positioning device 12, data transmission device 13, and data analysis and management device.

The network system 10, which performs as a data transmission medium, is selectively a wired network system or a wireless network system; commonly, the wired network system is, e.g. Ethernet; the wireless network system is, e.g. wireless local area network (WLAN), nested Global System for Mobile Communications (GSM), General Packet Radio Service (GPRS), 3G mobile communication systems, or WiMax network system.

The air pollution detecting device 11 detects the quantity of air pollutants. In the present embodiment, the air pollutants detected by the air pollution detecting device 11 are substances such as carbon dioxide (CO₂), carbon monoxide (CO), sulfur dioxide (SO₂), nitric oxide (NO), nitrogen dioxide (NO₂), nitrous oxide (N₂O), suspended particles (PM 10 or PM 2.5), or ozone (O₃).

The positioning device 12 locates the air pollution detecting device 11. To perform analysis on air pollution status of the surroundings, the air pollution detecting device 11 must be located, preferably, the air pollution detecting device 11 and the positioning device 12 are located closely for acquiring accurate position of the air pollution detecting device 11 by perceiving the location of the positioning device 12. A global positioning system (GPS) device is commonly adopted to function as a positioning device 12. The global positioning system divides the globe into a plurality of area blocks and the gives a number to each area block, and then utilizing satellites to transmit precise positioning signal to the earth. Therefore, with a GPS receiver, a user is capable of obtaining position data of global positioning.

The data transmission device 13 transmits air pollution data detected by and received from the air pollution detecting device 11 and position data received from the positioning device 12 via the network system 10. Therefore, any transmission apparatuses of wired network and wireless network can function as the data transmission device 13, e.g. a mobile phone, a personal digital assistant, a notebook computer, etc.

The data analysis and management device 14 receives air pollution data and position data from the data transmission device 13, and performs an analysis and management process on the air pollution data and the position data. Also, the data analysis and management device 14 performs processes of analysis, storing, and application on the received data.

In an embodiment, the air pollution detecting device 11 detects air pollutants, and the positioning device 12 obtains position data of a related area where the air pollution detecting device 11 is located; subsequently, the data are transmitted back to the data analysis and management device 14 in real time via the data transmission device 13 for analyzing. Preferably, the air pollution detecting device 11 is allocated to a moving vehicle or paraphernalia worn by a moving human being, such as a watch, cell phone, helmet, clothing, pants, shoes, or belt. Therefore, air pollution data are obtained while the location of the vehicle or location of the moving human being's paraphernalia is continuously changing. Preferably, if a plurality of users equipped with the air pollution detecting device 11 and the positioning device 12 are distributed over various geographic areas, air pollution information of a vast geographic area is obtainable.

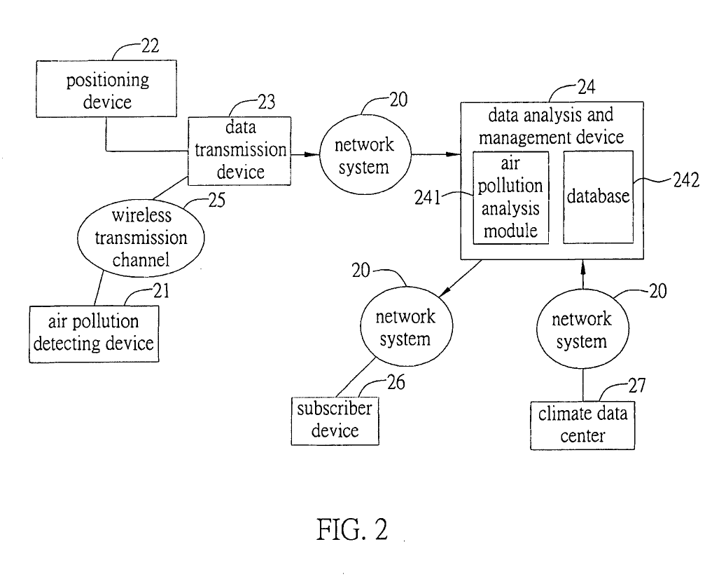

Referring to FIG. 2, which is an application architecture diagram of a specific embodiment of the air pollution detection system of the present invention, in this embodiment, the air pollution detection system comprises a network system 20, an air pollution detecting device 21, a positioning device 22, a data transmission device 23, a data analysis and management device 24, a wireless transmission channel 25, a subscriber device 26, and a climate data center 27.

In operation of the air pollution detection system of the present invention, the air pollution detecting device 21 has to use the wireless transmission channel 25 to transmit air pollution information to the data transmission device 23; the wireless transmission channel 25 adopts wireless transmission technique, and since distance between the air pollution detecting device 21 and the data transmission device 23 is short, the wireless transmission channel 25 can be established by adopting short distance wireless transmission technique; common short distance wireless transmission techniques are Bluetooth transmission, ZigBee transmission, infra-red ray transmission and/or wireless local area network transmission.

Next, the data transmission device 23 has to use the network system 20 to transmit the air pollution data and the position data received by the positioning device 22 to the data analysis and management device 24; in the present embodiment, the data analysis and management device 24 further comprises an air pollution analysis module 241 and a database 242; the air pollution analysis module 241 is for analyzing the air pollution data and the position data received by the data analysis and management device 24; and the database 242 is for storing analyzed information of the air pollution analysis module 241; therefore, with operations of the two modules, the data analysis and management device 24 is capable of obtaining air pollution information of each area and then storing the information in the database 242.

Unlike the embodiment shown in FIG. 1, the embodiment shown in FIG. 2 additionally teaches the subscriber device 26 and the climate data center 27. The subscriber device 26 is a common data transceiver, such as a mobile phone, personal digital assistant, notebook computer, or desktop computer. Performance of the subscriber device 26 is similar to that of the data transmission device 23. The data analysis and management device 24 transmits air pollution information according to a user's request or system setting thereof to the subscriber device 26 via the network system 20. A user equipped with the subscriber device 26 is capable of controlling over air pollution situation of each area in real time by accessing the database 242 of the data analysis and management device, and then promptly taking preemptive measures.

In order to provide the user with a convenient means of obtaining related messages, in the present embodiment, the data analysis and management device 24 is further connected with the climate data center 27. The climate data center 27 is a climate monitoring unit, such as weather bureau, local weather observatory, or civil weather and evaluation of risk thereof, etc. By being connected to the climate data center 27, the data analysis and management device 24 is capable of obtaining a great deal of climate data, e.g. temperature, humidity, wind speed, atmospheric pressure, and/or weather state, and then storing the climate data in the database 242. Therefore, in addition to the air pollution information, a user is able to, via the subscriber device 26, request the data analysis and management device 24 to transmit climate information or integrated local surrounding data for enabling the user to control overall climate status more precisely.

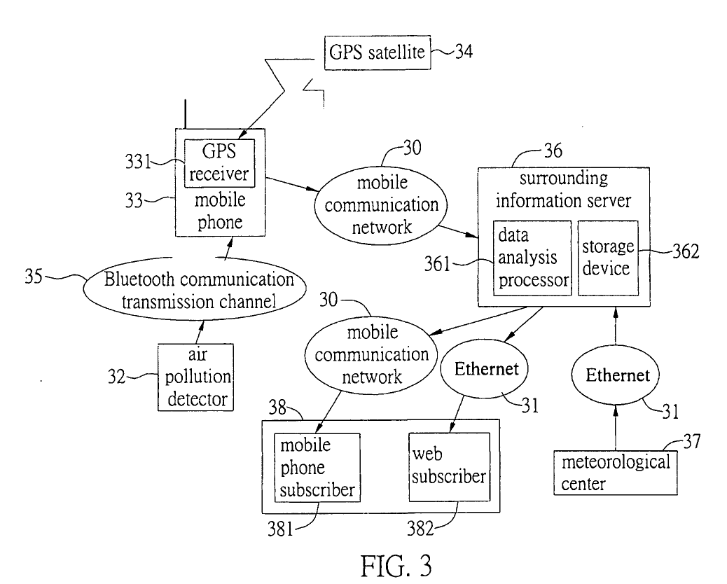

Please refer to FIG. 3, which is an application architecture diagram illustrating another specific embodiment of an air pollution detection system of the present invention. As described earlier, to achieve the objectives of the present invention, in the present embodiment, a plurality of air pollution detecting devices 32 are selectively installed in vehicles, motorbikes, bicycles, or users' portable paraphernalia, such as a helmet worn by a motorbike rider. Air pollution information of various geographic locations over a vast area is obtainable while the vehicles or the users keeping moving around a vast place. Users can send air pollution information with a mobile phone 33. Preferably, the mobile phone 33 comprises a GPS receiver 331 capable of receiving position signal from a GPS satellite 34. The air pollution information between an air pollution detector 32 and the mobile phone 33 is transmitted via Bluetooth communication transmission channel. After obtaining air pollution information and position information, the mobile phone 33 transmits the information to an environment information server 36 via a mobile communication network 30. The environment information server 36 comprises a data analysis processor 361 and a storage device 362. After sending information back to the environment information server 36, each air pollution detector 32 is to obtain air pollution state information by means of operation of the data analysis processor 361. Then, the information is stored in the storage device 362 for a subsequent analysis process and application of the air pollution detection system of the present invention.

In addition, the environment information server 36 can be connected to a meteorological center 37 via a network, e.g. Ethernet 31 or others, for obtaining a great deal of climate data, and then storing the obtained climate data in the storage device 362. Therefore, in addition to the air pollution information, the storage device 362 also stores integrated local environment information.

The subscriber device 38 comprises a mobile phone subscriber 381 and a web subscriber 382. The environment information server 36 is able to initiatively transmit the air pollution information and other climate information to the mobile subscriber 381 and the web subscriber 382, or passively transmit related information upon request of the subscriber device 38.

In a preferred embodiment, the environment information server 36 creates geographic information from local environment information, and is capable of transmitting the geographic information to the subscriber device 38, thereby allowing a user to control overall surrounding climate condition via map mode messages and select or set moving path thereof according to the geographic information.

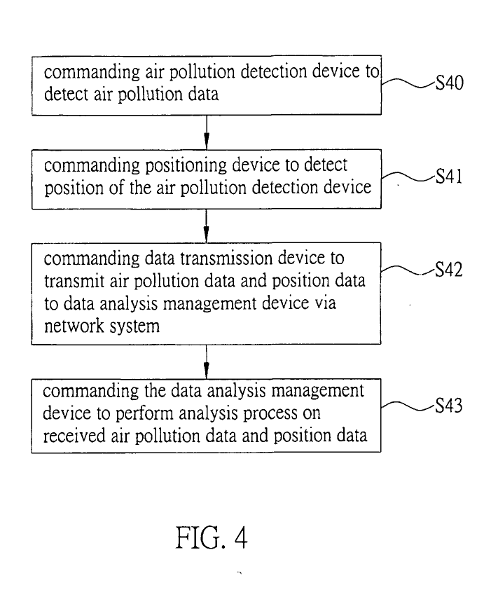

Referring to FIG. 4, which is a flowchart of air pollution detection method of the present invention, the air pollution detection method of the present invention is applicable to an air pollution detection system, and the air pollution detection system comprises an air pollution detecting device, positioning device, data transmission device, and data analysis and management device. The air pollution detection method comprises the following steps.

In step S40, air pollution information is detected by the air pollution detecting device. The air pollution detecting device detects pollutants, such as carbon dioxide, carbon monoxide, sulfur dioxide, nitric oxide, nitrogen dioxide, nitrous oxide, suspended particles, and ozone. To obtain air pollution information of a vast area, the air pollution devices are installed at vehicles or a human being's paraphernalia, such as a watch, cell phone, helmet, clothes, pants, shoes, or belt. Then, air pollution information of various area is continuously collected while the vehicle or the human being is moving. Afterward, proceed to step S41.

In the step S41, the air pollution detecting device is located by the positioning device. A global positioning system (GPS) device usually functions as the positioning device, receiving position data from a GPS satellite via a GPS receiver. Afterward, proceed to step S42.

In the step S42, the data transmission device transmits air pollution data and position data to the data analysis and management device via the network system. The network system functions as a data transmission medium and comprises a wired network system and/or a wireless network system. For instance, the wired network system can be Ethernet, and the wireless network system can be wireless local network system, nested mobile communication system, GPRS, 3G mobile communication system, and/or WiMax network system. Compared with the network system, the data transmission device can be a mobile phone, personal digital assistant, and/or notebook computer. In a preferred embodiment, the air pollution detecting device is connected with the data transmission device via wireless transmission technique; for example, Bluetooth transmission technique, ZigBee transmission technique, infra-red ray transmission technique, and/or wireless local network transmission technique. Finally, proceed to step S43.

In the step S43, the data analysis and management device performs an analysis process on received air pollution data and position data for generating air pollution information of multiple areas.

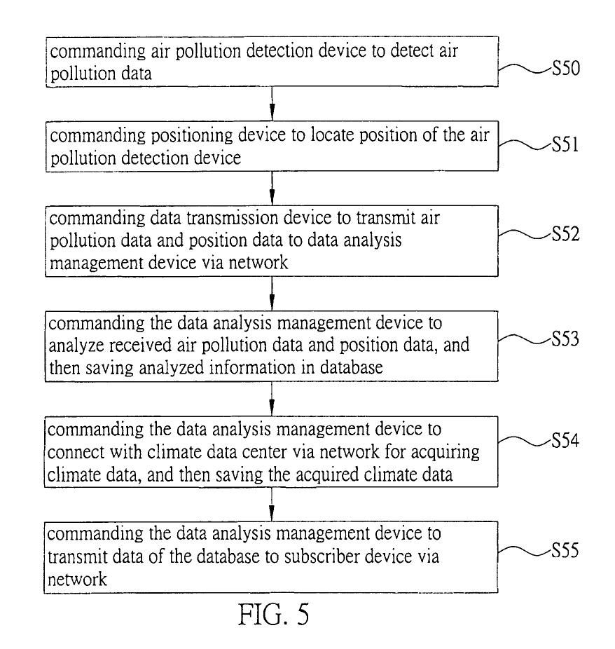

Please refer to FIG. 5, which is a flowchart illustrating a specific embodiment of air pollution detection method of the present invention. Compared with FIG. 4, steps S50 through S52 are the same as steps S40 through S42, and thus no repeated description is given hereafter.

In step S53, the air pollution data and the position data received by the data analysis and management device are analyzed, and then the analyzed information is stored in the database for subsequent application of the detected air pollution data. Finally, proceed to step S54.

In the step S54, the data analysis and management device is connected to the climate data center via the network system for accessing climate data of the climate data center, and then the accessed data is stored in the database. The climate data includes, but is not restricted to, temperature, humidity, wind speed, atmospheric pressure, and/or weather status. Afterward, proceed to step S55.

In the step S55, the data analysis and management device transmits data stored in the database to a subscriber device via the network system; the subscriber device can be but not restricted to mobile phone subscriber and web subscriber; therefore, in addition to air pollution information, a user is able to request the data analysis and management device for sending climate data or integrated local surrounding data, thereby enabling a user to control overall climate status more precisely.

In another preferred embodiment, said step S55 further comprises: creating geographic information from data stored in the database, and then transmitting the geographic information to the subscriber device.

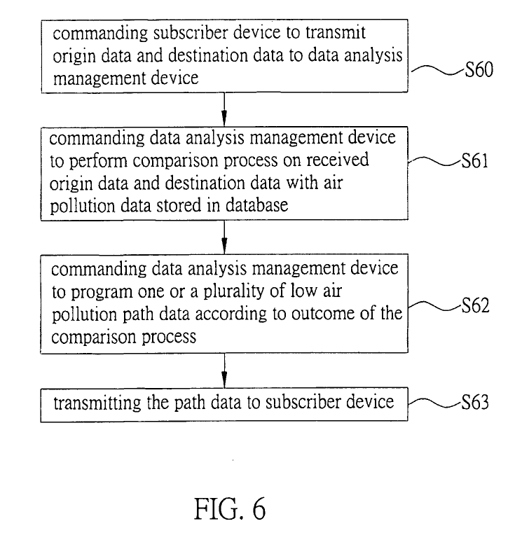

Please refer to FIG. 6, which is a flowchart illustrating an air pollution path planning method of the present invention; the air pollution path planning method of the present invention is applicable to air pollution detection system. The air pollution path planning method comprises the following steps.

In step S60, the subscriber device transmits origin data and destination data to the data analysis and management device. To avoid entry into any area with serious air pollution while moving from a certain area to another area, a user has to provide the data analysis and management device with origin location and destination location for subsequent analysis. Afterward, proceed to step S61.

In the step S61, the data analysis and management device performs a comparison process on the received origin data and destination data with air pollution data stored in the database; wherein areas near origin location and destination location are compared with one another, and then start searching for areas of better air quality; afterward, proceed to step S62.

In the step S62, the data analysis and management device generates one or a plurality of low air pollution paths based on the outcome of the comparison process; in a preferred embodiment, in addition to air quality, consideration is given to distance, traffic status, weather situation, etc., thereby generating a plurality of paths for selection. Afterward, proceed to step S63.

In the step S63, transmitting the paths to the subscriber device.

With the air pollution path planning method of the present invention, a user is capable of finding out a most suitable path and avoiding air pollution areas, even avoiding bad weather area, thereby providing a user with a more comfortable route.

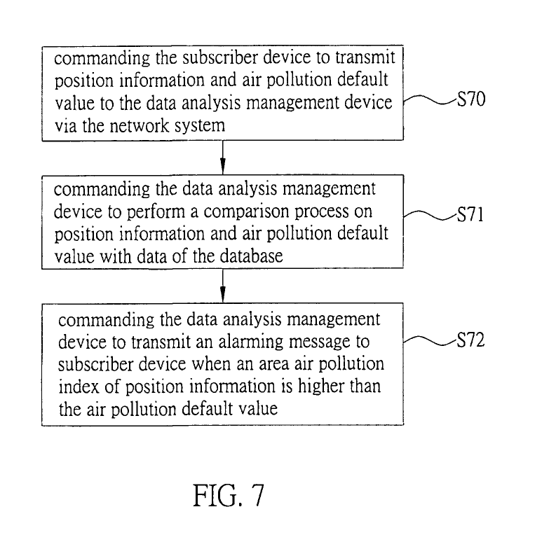

Please refer to FIG. 7, which is a flowchart of air pollution alarming method of the present invention; the air pollution alarming method of the present invention is applicable to air pollution detection system, and the air pollution alarming method comprises the following steps.

In step S70, the subscriber device transmits position data and an air pollution default value, e.g. maximum allowable pollutant density, to the data analysis and management device via network system. Afterward, proceed to step S71.

In the step S71, the data analysis and management device performs a comparison process on the position data and the air pollution default value with data of the database. The comparison process involves performing a continuing comparison process on local air pollution detection outcome with the air pollution default value. Afterward, proceed to step S72.

In the step S72, when air pollution of area of the air pollution detecting device is higher than the air pollution default value, the data analysis and management device transmits an alarming message to the subscriber device.

With the air pollution alarming method of the present invention, a user is able to receive an alarming message in a serious air pollution situation in real time, thereby enabling the user to take protective actions accordingly.

Furthermore, given implementation of the foresaid air pollution detection system and method of the present invention, the following effects are achievable.
(1) Increasing the scope of application of air pollution detection equipment; by installing the air pollution detecting device on a moving object and using wireless network transmission technique, data searching range is greatly increased, thereby enhancing performance of the air pollution detection system.
(2) Enabling the general public to obtain air pollution information in a real-time, convenient manner, for example, allowing the general public to connect devices in their possession, e.g., cell phones, to the air pollution detection system of the present invention so that the general public is able to obtain air pollution information in real time and conveniently.
(3) Intensifying interaction between the air pollution detection system and the general public, and further enhancing performance of the present system; since the present system provides capabilities of path planning and warning of air pollution, consequently intensifying interaction with the general public; accordingly increasing the general public's willingness to install the air pollution detecting devices at vehicles or accessories thereof. When more and more people are willing to be equipped with the air pollution detecting devices, it means there are more air pollution detecting devices operating in the surroundings, and thus the present system is more capable of controlling air quality status of the surroundings.

In conclusion, the air pollution detection system and method of the present invention are capable of increasing air pollution detection scope greatly and informing a user of an air pollution situation in real time, and the present invention provides the government or related communities with benefit of instant improvement on air pollution, and enabling the public to take immediate, preventive measures against serious pollution situation, thereby indirectly improving public health.

The foregoing descriptions of the detailed embodiments are only illustrated to disclose the features and functions of the present invention and not restrictive of the scope of the present invention. It should be understood to those skilled in the art that all modifications and variations carried out according to the spirit and principle in the disclosure of the present invention should fall within the scope of the appended claims.

What is claimed is:

1. A system for detecting air pollution, which is applicable to a network system, the system comprising:
an air pollution detecting device for detecting air pollutants;
a positioning device for locating the air pollution detecting device;
a data transmission device for transmitting air pollution data detected by and received from the air pollution detecting device and position data received from the positioning device via the network system; and
a data analysis and management device for receiving the air pollution data and the position data transmitted from the data transmission device, and then performing process of analysis and management on the data.

2. The system of claim 1, wherein the air pollutants detected by the air pollution detecting device are substances selected from the group consisting of carbon dioxide, carbon monoxide, sulfur dioxide, nitric oxide, nitrogen dioxide, nitrous oxide, suspended particles, and ozone.

3. The system of claim 1, wherein the air pollution detecting device is installed on paraphernalia worn by a human being, the paraphernalia being at least one selected from the group consisting of watch, cell phone, helmet, clothes, pants, shoes, and belt.

4. The system of claim 1, wherein the positioning device is a global positioning system device.

5. The system of claim 1, wherein the network system is at least one of a wired network system such as Ethernet, and a wireless network system such as a wireless local area network, a nested mobile communication system, a GPRS, a 3G mobile communication system, and/or a WiMax network system.

6. The system of claim 1, wherein the data transmission device is at least one selected from the group consisting of a mobile phone, a personal digital assistant, and a notebook computer.

7. The system of claim 1, wherein the air pollution detecting device is connected to the data transmission device via a wireless transmission channel employing at least one selected from the group consisting of Bluetooth transmission, ZigBee transmission, infra-red ray transmission, and wireless local area network transmission.

8. The system of claim 1, wherein the data analysis and management device further comprises:
an air pollution analysis module for analyzing the air pollution data and the position data received by the data analysis and management device; and
a database for storing analyzed information of the air pollution analysis module.

9. The system of claim 8, wherein the database is connected to climate data center via a network system for obtaining and storing climate data, the climate data being at lease one selected from the group consisting of temperature, humidity, wind speed, atmospheric pressure, and weather status.

10. The system of claim 1, further comprising a subscriber device, such as a mobile phone subscriber and a web subscriber, for receiving data from the database via the network system.

11. The system of claim 10, wherein the data analysis and management device creates geographic information from data of the database, and then transmits the geographic information to the subscriber device.

12. An air pollution detection method applicable to an air pollution detection system, wherein the air pollution detection system comprises an air pollution detecting device, a positioning device, a data transmission device, a data analysis and management device, and a database, the air pollution detection method comprising the steps of:
(1) detecting air pollution data by the air pollution detecting device;
(2) locating the air pollution detecting device by the positioning device;
(3) transmitting, by the data transmission device, the air pollution data and the position data to the data analysis and management device via a network system; and
(4) performing, by the data analysis and management device, an analysis process on received air pollution data and position data.

13. The method of claim 12, wherein the air pollution detecting device detects pollutants selected from the group consisting of carbon dioxide, carbon monoxide, sulfur dioxide, nitric oxide, nitrogen dioxide, nitrous oxide, suspended particles, and ozone.

14. The method of claim 12, wherein the air pollution detecting device is installed on paraphernalia worn by a human being, the paraphernalia being at least one selected from the group consisting of watch, cell phone, helmet, clothes, pants, shoes, and belt.

15. The method of claim 12, wherein the positioning device is a global positioning system device.

16. The method of claim 12, wherein the network system is at least one of a wired network system such as Ethernet, and a wireless network system such as a wireless local area network, a nested mobile communication system, a GPRS, a 3G mobile communication system, and/or a WiMax network system.

17. The method of claim 12, wherein the data transmission device is at least one selected from the group consisting of mobile phone, personal digital assistant, and notebook computer.

18. The method of claim 12, wherein the air pollution detecting device is connected to the data transmission device by means of wireless transmission technique employing at least one selected from the group consisting of Bluetooth transmission, ZigBee transmission, infra-red ray transmission, and wireless local area network transmission.

19. The method of claim 12, wherein step (4) further comprises the steps of:
(4-1) analyzing the air pollution data and the position data received by the data analysis and management device; and
(4-2) storing information analyzed by the data analysis and management device in the database.

20. The method of claim 19, further comprising the step of:
(4-3) connecting the data analysis and management device to a climate data center via the network system for obtaining climate data, and then storing the climate data in the database, wherein the climate data is at least one selected from the group consisting of temperature, humidity, wind speed, atmospheric pressure, and weather status.

21. The method of claim 12, wherein the air pollution detection system further comprises a subscriber device, such as a mobile phone subscriber and a web subscriber, and the air pollution detection method further comprises the step of:
(5) transmitting, by the data analysis and management device, data of the database to the subscriber device via the network system; creating geographic information from data of database; and then transmitting the geographic information to the subscriber device.

22. An air pollution path planning method applicable to the air pollution detection system of claim 15, the air pollution path planning method comprising the steps of:
(1) transmitting, by the subscriber device, origin data and destination data to the data analysis and management device;
(2) comparing the received origin data and destination data with air pollution data of the database by the data analysis and management device;
(3) planning, by the data analysis and management device, one or a plurality of low air pollution paths according to the outcome of the comparing step; and
(4) transmitting the paths to the subscriber device.

23. An air pollution alarming method applicable to the air pollution detection system of claim 15, the air pollution alarming method comprising the steps of:
(1) transmitting, by the subscriber device, position data and air pollution default value to a data analysis and management device via a network system;
(2) comparing the position data and the air pollution default value with data of the database by the data analysis and management device; and
(3) transmitting, by the data analysis and management device, an alarming message to the subscriber device if an air pollution value of area denoted by the position data is higher than the air pollution default value.
